(19) United States
(12) Patent Application Publication
(10) Pub. No.: US 2012/0078812 A1
(43) Pub. Date: Mar. 29, 2012

(54) System and method to analyze current portfolio holdings for individuals and then provide automated potentially suitable trade suggestions by using database cross-referencing, websites and internet

(76) Inventor: Matthew Joseph McGrath, New York, NY (US)

(21) Appl. No.: 12/890,773

(22) Filed: Sep. 27, 2010

(51) Int. Cl. G06Q 40/00

(52) U.S. Cl. 705/36 R

(57) ABSTRACT

A system and method to analyze an individual's current portfolio of mutual funds, exchange traded funds, stocks and bonds by cross-referencing the holdings with open and proprietary databases and then to provide automated potentially suitable trade suggestions through website and the internet by categorizing and evaluating current holdings and selecting better replacement holdings available currently through retail financial markets with an emphasis on asset allocation theory, but only if the recommendation is potentially suitable and available to the investor.

### FIELD OF THE INVENTION

The present invention is related to computer software and more specifically to computer software for financial analysis.

### BACKGROUND OF THE INVENTION

Currently, the investor must rely on an investment advisor to determine whether a security or group of securities are suitable for the investor or the investor must do such determination on their own. The first option is a very expensive choice as the investor must pay full-service brokerage fees. Often in addition to the full-service brokerage fees, the investor must pay embedded management and underwriter fees that are charged on some securities products. The second option is much cheaper, but it does not provide any security that the right choice gets made. Some businesses provide free but limited advice but only show whether a specific security is suitable for the investor or not. They do not provide a full review of the portfolio of investments that the investor currently holds. Finally, unlike a financial advisor or stock broker who received hours of training, the majority of the population has no specific knowledge or experience with investing in securities.

Another factor to consider is that even if the investor opts-in to employ a full-service investment advisor, it will be a difficult and expensive task for the investment advisor to collect all the information about the investor's accounts, sort them and arrange them for the portfolio evaluation. Hence, the individual is also at risk to end up with investments that provide a continuous income to the advisor at the expense of suitability for the individual.

As a result, there is a gap between businesses that provide expensive full-service personal advice (commonly known as full-service brokerage or investment advisors) and businesses that provide very limited or no advice at all (commonly known as discount brokers). In addition, the current portfolio evaluation process requires lots of time and manual work. Therefore, it may turn out to be very costly regardless whether it's done by an investment advisor or by an investor himself. To resolve this problem, there is a need for an automated system and method that can accurately analyse the financial data to determine whether the portfolio fits the investor's goals without causing significant costs to the investor.

### SUMMARY OF THE INVENTION

This invention is a new and innovative method and system, the utility of which is to provide an automated investment portfolio review based on an investor's investment style, his/her investments' management and underwriting fees, type of investment, and historical average return on the investment. The method and system also assigns a specific score and values that are used to evaluate the securities and investment portfolios. The method and system is useful to the public because it provides investors with an intermediate level of evaluation of their holdings, can suggest alternative trades, and can suggest corrections to the asset allocation amongst the types of the securities with little to no costs for the investor.

The invention is a system and method which categorizes securities using data from mutual fund companies, stock exchanges, banks and other sources. The system and method categorizes all investment securities and assigns specific values to them based on specific category: (a) to which asset class the security is exposed to, (b) the geographic location of the investments, (c) whether it is large or medium or small cap equity, and (d) whether it is value or growth equity style security. The information containing security name, ticker information and assigned values then will be stored in the central database for quick access and updated from time to time to ensure accuracy.

An investor, who wants a quick evaluation of their portfolio, will select the preferred investment and risk style and then enter the account information on the website using the website's forms and wizards. The website will access the account and download data about the securities owned by the investor automatically. The website than compare data with the database and assign specific values to each security. In order to compare, the match will be done by ticker information first. The match will be considered to occur if all symbols match exactly the symbols for the security in the database. If for some reason the account does not have a uniform ticker listed for the security, the system will make an attempt to identify the security by the security name using the same methodology.

The website also creates a hypothetical model perfect portfolio based on the risk and style selected by the investor. The hypothetical perfect portfolio will have values assigned that will reflect a perfect mix of securities arranged based on (a) which asset class the security is exposed to, (b) the geographic location of investment, (c) whether it is large or medium or small cap equity, and (d) whether it is value or growth equity style security. The hypothetical perfect portfolio will be assigned a maximum value the actual portfolio can get.

Once the website has gathered the investor's securities information and assigned specific values to each security, the website compares the assigned values of the current securities mix and then compares those to the hypothetical perfect portfolio. The current portfolio will be assigned a value from zero to the maximum amount set by the hypothetical perfect portfolio, which could be set, as an example, at 100. The result will be provided to the investor on the computer monitor.

The website can also provide feedback as to the areas of improvement by displaying the difference between hypothetical perfect portfolio and current securities' portfolio. The system will also suggest trades that would improve the portfolio score by suggesting sale of the securities that are in excess over the hypothetical portfolio position and by suggesting purchasing securities that would increase the values of the portfolio to have the best match to the hypothetical portfolio.

In order to create a meaningful suggestion to the investor, the system suggests changes based on specific parameters. When suggesting a sale it will suggest the sale of a security that is in excess of the values over the hypothetical portfolio position, it will choose the security that has lowest overall return and highest management fees. When suggesting a purchase of the security that would bring the portfolio values as close as possible to the hypothetical portfolio, it sorts through database sorting securities first for the securities that have lower management fees, then sorting the results for securities with higher return, better Sharpe ration and then for the security that has a higher third party rating or ranking (optional). Thus, the suggested security for purchase will be always one of the best available market choices.

The invention features an increased use of technology to create efficiencies and streamlining in the portfolio evaluation process. The portfolio analysis method would be the quickest, accurate and most valuable method available on the market today. The investor does not even need a working knowledge of existing securities in his or her portfolio because the system automatically pulls all the relevant information, assigns values and provides a complete overview in one step. The system can be run at very low costs but still serve multiple investors. The results can be provided instantly. Finally, the system can point out the basic areas of improvement and suggest transactions that can improve the portfolio allocation while suggesting only the best securities available on the market.

The reason this has never been done before is because (1) the data collection technology was not available until recently, (2) the prioritization of the portfolio allocation strategy in investment management was not widely accepted in both the academic and the business world until recently, (3) the back-end computer system would have been too costly and time consuming to implement by an individual investor, so nobody would even have considered to develop it for personal portfolio purposes, (4) the financial industry would not develop this kind of product due to the conflicts of interest it would have created with its current operations and sales channels, (5) the number of traded securities such as Exchange Traded Funds (ETFs) were not diverse enough to provide the necessary variety to achieve portfolio allocations diversified in sufficient number of asset classes.

### BRIEF DESCRIPTION OF THE DRAWINGS

FIG. 1 shows a simplified view of initial set up required for the method

FIG. 2 shows a simplified view of the system

FIG. 3 shows a flowchart of the method for suggested trades

FIG. 4 shows a flowchart of the method for portfolio analysis

### DETAILED DESCRIPTION OF THE INVENTION

The new system and method that provides an automated investment portfolio review takes full advantage of technological advances to streamline the review process and obtain information from the investors, banks and financial industry. Ideally, in its most preferable embodiment, it would combine computer hardware, data and computer readable statements and instructions, and use the power of internet technology and innovative procedures to spread and reduce the costs. The system and method in addition provides a useful list of suggested trades that are potentially suitable to the particular user.

“Fund,” as used herein and throughout this description, refers to any collective investment. Examples of a fund include but are not limited to a mutual fund, a money market fund, a stock index, a hedge fund, exchange traded fund, etc.

“Security,” as used herein and throughout this description, refers to any publicly traded investment. Examples of a security include but are not limited to a stock, bond, mutual fund, exchange traded fund, etc.

“Investor,” as used herein and throughout this description, refers to the user of the system and method.

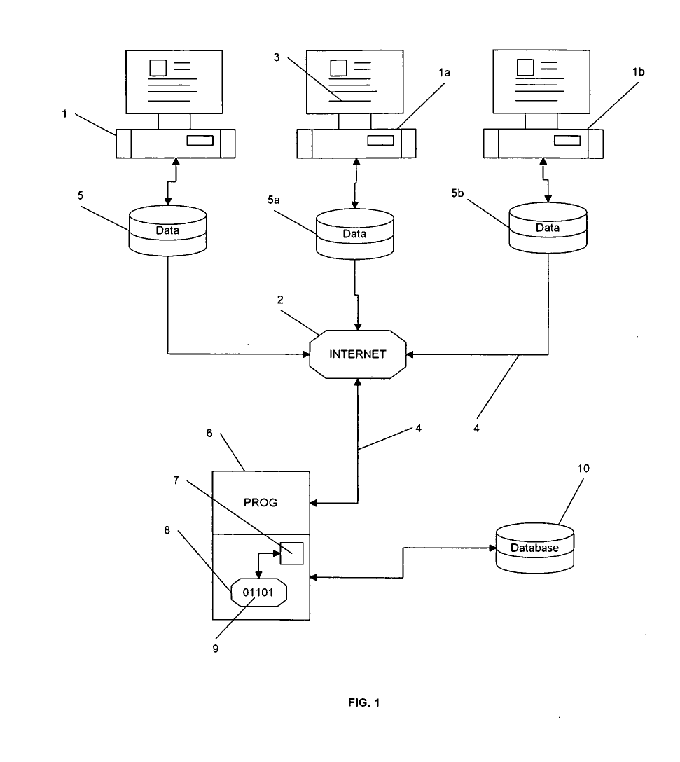

The preferred initial hardware embodiment required and its functionality is shown in FIG. 1. The system comprises a computer-readable medium (8) in a server (6), connected (4) to the internet (2), which in turn is connected either with wires or remotely to a plurality of remote terminals (1) of financial data providers who have uploaded financial information (3). A specially designed program (9), comprising computer readable statements and instructions, is stored in the computer readable medium (8), written in a language such as HTML, PHP, ASP, Sal or any other computer programming language and is capable, when run by a processor (7), of sorting data (5) provided by financial data providers and reorganizing into a new database (10) that can be stored in the computer readable medium. The database (10) can be updated from time to time by accessing updated data (5) using internet (2) and internet connection (4).

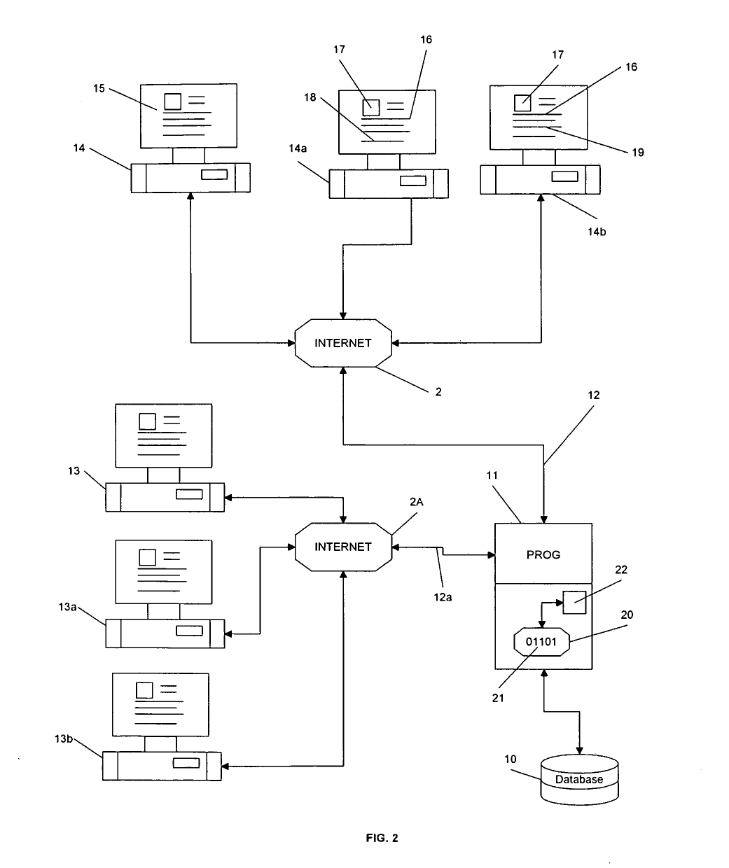

The complete hardware embodiment and the functionality of the method within hardware embodiment are shown in FIG. 2. The system comprises a computer-readable medium (20) in a server (11), connected (12) to the internet (2), which in turn is connected either with wires or remotely to a plurality of remote user terminals (14). The computer-readable medium (20) in a server (11) is also connected (12a) to the internet (2a), which in turn is connected either with wires or remotely to a plurality of remote terminals (13) of the financial institutions. A specially designed software application (21), comprising computer readable statements and instructions, is stored in the computer readable medium (20), written in a language such as HTML, PHP, ASP, Sal or any other computer programming language and is capable, when run by a processor (22), of processing information (15) provided by remote user terminals (14) and financial institution terminals (13) over the internet (2 and 2A) and of processing information from the database (10) that has been created in the initial stage. The program is configured to display information on a remote user terminal (14) including information from the database such as current portfolio information (17), current holdings and current asset allocation (16), and proposed changes to the asset allocation along with suggested trades (19). The system is designed to receive information entered by multiple users on their terminals (14, 14a, and 14b). Using the information entered by the user, such as account numbers and passwords, the server would also connect to the appropriate financial institution terminals (13, 13a, and 13b) and extract information from the user accounts, such as securities held and their quantity.

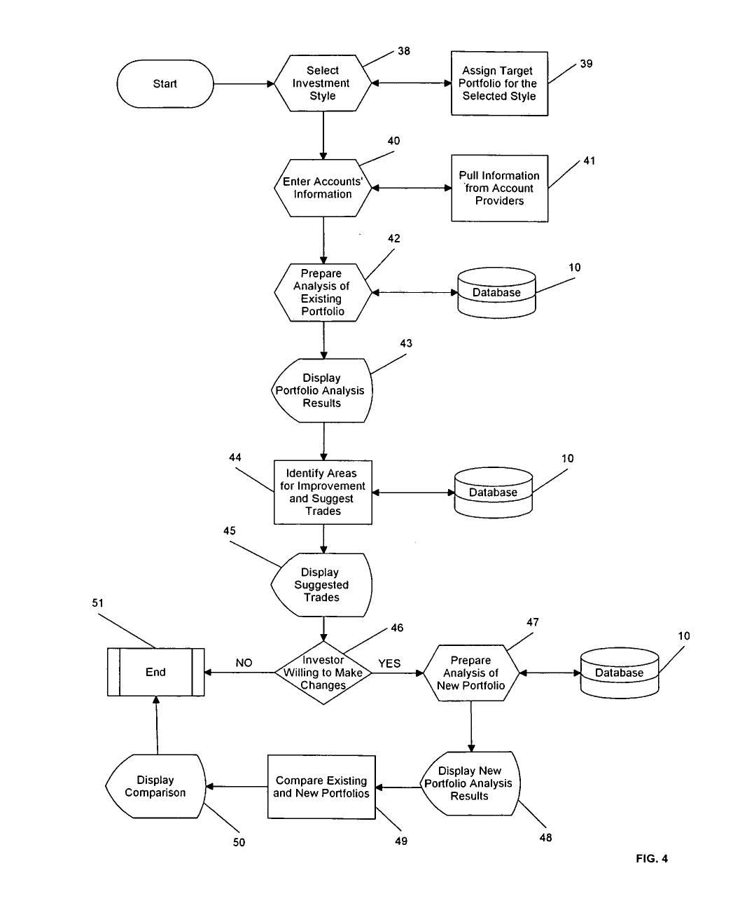

The functionality of the preferred embodiment of the system is shown in FIG. 4. First, the database should be created by a specially designed program in the server as described above and in FIG. 1. Next, the user of the system would connect to the server that can process information from the database as described above and in FIG. 2. The server should be also connected via internet to the financial institutions as described above and in FIG. 2. First, using forms or wizards, the user would select his investment style (38) that would correspond to his objectives and risk tolerance. Based on the investment style, the software application would assign a portfolio allocation (39) and then assign the highest score to it making it a perfect portfolio for the corresponding investment style. Next, the user would provide account information (40) using forms or wizards that will be in turn collected by the server, processed by the software application and used to pull financial information about the user's security holdings (41). The data about their current holdings will be analyzed (42) by the software application using information about the security in the database (10) that has been already created in the initial stage.

The system then would display the current portfolio analysis and provide information about the current holdings (43), such as, but not limited to, investment categories, rate of return, diversification, and risk analysis.

The software application then would analyse the current holding against the assigned perfect portfolio (44), using information from the database (10), and identify areas for improvement, such as, but not limited to asset allocation between types of securities, allocation between types of assets, and geographical diversification. In addition to the identification of areas for improvement, the system would display suggested trades that can be done to improve the current portfolio (45). At this point, the investor will receive the complete information about the current portfolio and how to improve it. Therefore, the investor can choose (46) whether to leave and end the process (51) or go ahead and see how the new portfolio would compare to the current portfolio if the suggested trades would get done.

If the investor wants to see how the new portfolio would compare to the current portfolio when the suggested trades are done, the investor would select, using forms and wizards, the possible changes to be made and the application software would prepare a new portfolio analysis (47) using information from the database (10) and would display results to the investor (48). The software application would also compare the current portfolio against the new portfolio as well as against the perfect portfolio (49). Finally, the comparison results will be displayed to the investor (50) showing how portfolio would improve if trades are made. After the displaying all the results, the process would end (51).

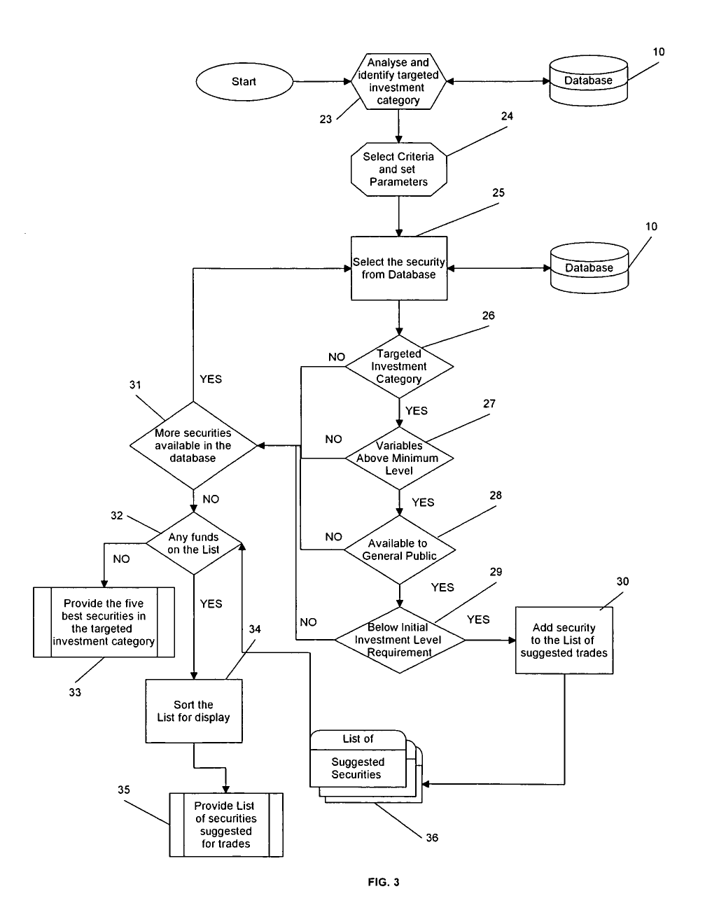

The functionality of the preferred embodiment of the system that provides a list of securities for suggested trades is shown in FIG. 3. The software application would determine the changes needed in the portfolio by identifying in what investment category securities needed to be sold and in what investment category securities needs to be bought (23). The software application would select from the current pool securities that needed to be sold by choosing the security with lowest rate of return in category of the investment that needs to be reduced. In order to do so, the software would obtain information from the database (10). Next, the application software would set criteria and parameters for the security that is needed in the portfolio (24), but would limit them to the rate of return of security to be sold by setting that rate as a minimum. In addition, the minimum may be set for other parameters, such as third party rating or ranking, risk ratio, fees, initial investment requirements, earnings per share, minimum assets under management and so on. As an example, in case of the fund, the fund data would be first analyzed and software would identify targeted investment category (23) and then the fund would be analyzed against the select criteria, such as third party rating or ranking, return over risk ratio, management fees, initial investment requirements, rate of return, and minimum assets under management and set those fund parameters (24) as a minimum value.

The software application then would analyse each security (25), using information from the database (10). The software application would test whether the new security is within targeted investment category (26), whether security parameters are above the previously set minimum values (27), whether the security is available to a general public (28) and whether new security has lower initial investment amount (29). If new security fails to meet any of the above mentioned parameters or tests, the software application would ignore that security and analyse another security from the database. If new security meets all the parameters and tests, it will be placed (30) on the list of suggested securities (36).

The application software would analyse every security in the database until every security has been processed (31). If all the security have been processed and no securities were placed on the suggested funds list (32) the software would display a number, such as five, of the best securities available in the needed investment category sorted as per rate of return (33) and the process would end. If any securities have been placed on the suggested securities list, the securities will be sorted (34) by their rate of return or by using the criteria and parameters selected by the investor (35) as a list of suggested replacement securities. The process would end after the sorted suggested funds are provided and displayed to the investor.

Modifications and variations to this invention will be apparent to those skilled in the art which will not depart from the spirit or scope of this invention.

I claim:

1. A system for processing investment product information comprising:
a. a computer-readable medium;
b. an investment product database having information about a plurality of securities;
c. a server connected to the investment product database;
d. a processor;
e. a plurality of remote terminals;
f. computer readable statements and instructions residing in the computer readable medium, the statements and instructions configured to:
i. display information on a remote terminal;
ii. accept inputs from a remote terminal;
iii. accept an input from a user indicating current securities holdings;
iv. accept an input from the investment product data provider;
v. download information about the investment product from the investment product data provider.

2. The system of claim 1, wherein the information in the investment product database comprises information about the security, including, but not limited to, type, performance, category, availability to the public, minimum investment requirements, third party rating or ranking and risk ratio.

3. The system in claim 2, wherein the criteria comprises a plurality of If/Then commands based on any of the information in the fund database.

4. The system in claim 1, wherein the computer is a personal computer.

5. The system of claim 1 wherein the investor can input information about the investment product in order to generate a list of suggested replacement funds.

6. The system in claim 1 wherein the software application can provide a portfolio allocation based on the investment style entered by the user.

7. The system of claim 1 wherein the condition that suggests replacement of the investment product comprises of a series of steps: first, security must match specific category; second, the security should have better third party rating or ranking; third, the security should have better return, than lower risk; and finally, it should have lower expenses.

8. The system of claim 7 wherein the condition that suggest replacement of the investment product would also require the investment product to be available to general public and to match minimum initial investment level.

9. The system of claim 1, wherein the computer provides a user a list of suggested replacement securities in order to improve the portfolio diversification.

10. The system of claim 8 which is further configured to allow the investment products to be sorted by user.

11. A system for processing portfolio and investment product information comprising:
g. a computer-readable medium;
h. data information records having information about a plurality of investment products;
i. data information having information about a plurality of investment portfolios for each type of investment style.
j. a server connected to the internet;
k. a processor;
l. a plurality of remote terminals;
m. a plurality of remote terminals that contain data information records;
n. computer readable statements and instructions residing in the computer readable medium, the statements and instructions configured to:
i. display information on a remote terminal;
ii. accept inputs from a remote terminal;
iii. accept an input from an investor indicating current fund holdings;
iv. accept an input from the investment fund data provider;
v. download financial information from financial institutions that hold securities for the users.

12. The system of claim 11 which is further configured to allow server to access data information records having information about a plurality of investment products located in the plurality of remote terminals of financial data suppliers.

13. The system of claim 11 which is further configured to allow server to process financial data about a plurality of investment products and create a new investment products database.

14. The system of claim 11 which is further configured to allow server to update investment products database by accessing financial data from financial data providers.

15. The system of claims 1 and 11 which is further configured to allow server to download information about investment product holdings from financial institutions where the user has securities.

16. The system of claim 1 which is further configured to accept multiple requests from multiple users.

17. The system of claim 1 which is further configured to accept multiple requests from multiple users at the same time.

18. The system of claim 1 which is further configured to receive notifications and requests.

19. A computer readable memory for storing data for access by a processor carrying out the method of claims 1 and 11.

20. The system of claim 1 wherein the user is guided to input information about the fund by one or more wizards or pop ups.

21. The system of claim 1, which is further configured to send an instruction to the user indicating details, suggested terms and conditions, requirements and other information as may be required.

22. A computer readable memory having recorded thereon statements and instructions for interpretation and execution by a processor to carry out the method of claims 1 and 11.
